(19) United States
(12) Patent Application Publication
(10) Pub. No.: US 2025/0053395 A1
(43) Pub. Date: Feb. 13, 2025

(54) SYSTEM, METHOD AND COMPUTER PROGRAM PRODUCT FOR PROGRAM ANALYSIS

(71) Applicant: COMMISSARIAT A L’ENERGIE ATOMIQUE ET AUX ENERGIES ALTERNATIVES, PARIS (FR)

(72) Inventors: Sébastien BARDIN, Gif Sur Yvette (FR); Lesly-Ann DANIEL, Gif Sur Yvette (FR)

(21) Appl. No.: 18/722,874

(22) PCT Filed: Dec. 23, 2021
(86) PCT No.: PCT/IB2021/000953

§ 371 Date: Jun. 21, 2024

(51) Int. Cl. G06F 8/41

(52) U.S. Cl. CPC G06F 8/443

(57) ABSTRACT

A computer implemented method is provided for performing symbolic execution on a symbolic representation of a computer program comprising a sequence of software instructions represented at least by variables, memories and expressions. The method is operated on-the-fly and comprises for each software instruction of the computer program: analyzing an initial symbolic representation of a software instruction to determine if a simplification may be applied to any memory-access operation included in the initial symbolic representation of the software instruction; in case of determining a simplification, generating a simplified symbolic representation of the software instruction to replace the initial symbolic representation; and generating a new symbolic representation of the computer program with the simplified symbolic representation of the software instruction.

### FIELD OF THE INVENTION

The present invention relates to systems and methods for program analysis, and particularly it relates to a system and a method for generating an efficient Symbolic Representation (SR) of a program, allowing faster further analysis of the program.

### BACKGROUND ART

The general technical context of the present invention is the one of advanced automatic program analysis to identify bugs, security vulnerabilities or to determine opportunities for optimizations, among others.

Advanced program analysis techniques at some point rely on a transformation of a software Program Under Analysis (PUA) to a logical representation of its functional meaning. The symbolic form of such logical representation of a code is also known as a Symbolic Representation.

These advanced analysis techniques are at the heart of several approaches such as the symbolic execution and its many variants, the bounded model checking, the trace-oriented abstract interpretation, or the expression propagation in compilers, to name some.

Symbolic execution (also known as symbolic evaluation or symbex in short) is a means of analyzing a program without concretely executing it with real values, but executing it symbolically with symbolic values to determine what input values cause each part of a program to execute. The article of Cristian Cadar, Koushik Sen. “Symbolic execution for software testing: three decades later”, Communications of the ACM. Volume 56 (2), 2013. ACM, provides an overview of modern symbolic execution techniques.

FIG. 1 shows a standard architecture 100 and the process flow of a program analyzer using symbolic representation. The system uses as input a textual description of a program 102 to be analyzed, and provides as output 110, some results relative to relevant information about the program.

The textual description of the program under analysis (PUA) 102 may be in any form, such as source code, assembly code or may be an executable file.

The PUA is provided to a front-end module 104 which outputs 106 a symbolic representation of the whole program, which is a simplified, semantically-equivalent, representation of the PUA.

A symbolic representation allows reusing a core analyzer module among different input languages, conceptually closed enough from each other, even if concrete syntaxes are quite different.

The goal of the symbolic representation is to abstract away superficial differences in syntax and semantics, in order to provide different core analyzer modules 108 with a unified and minimal code representation.

The one or several core analyzer modules 108 receive as input the SR of the program performs various computations to output results of the analysis of the program. A core analyzer module may for example perform formal verification, automatic test generation, automatic insertion of program protections, code optimization and estimation of worst-case execution time.

A major difficulty for any program analysis is to handle from a symbolic representation, the operations related to memory-access manipulations. The basic operations in a memory (or an array) are the read one (defined as an operation of “load in memory from address a”) and the write one (defined as an operation of “store into memory at address a”). These operations are notoriously complicated to handle and to reason about since they are the basis of what is known as the “theory of arrays”, those resolution is an intractable problem (i.e. a NP-complete problem), and which can lead to dramatic performance issues when analyzing memory-intensive programs.

The intrinsic issue of processing memory-access operations for a program analyzer is that during symbolic execution of these operations, they may point to different memory cells depending on the runtime value of an address “a” (this is called the aliasing problem). This is an extremely hard situation to predict statically (i.e. without running the program).

The common mitigations to issues related to memory modeling with a symbolic representation, include the following options, which have each some drawbacks:
one approach is handling the memory-access operations as is (considering precisely all possible aliasing), but this yields to poor performance;
one approach is abstracting away the memory, but this leads to a dramatic loss of precision in the analysis, i.e. providing either false positives or false negatives;
one approach is simplifying the final symbolic representation of the memory through standard simplification rules taken from the theory of arrays, but this has two drawbacks: firstly such techniques are limited to the case where memory accesses (i.e., the addresses of load and store) are constant values, which is a rare situation in practice; secondly the simplification process is performed once the full translation of the program to a symbolic representation has been done, possibly leading to low performance.

The article of Vijay Ganesh and David L. Dill, “A Decision Procedure for Bit-Vectors and Arrays”. CAV 2007. LNCS 4590, pp. 519-531, 2007, explains why large arrays become a bottleneck in symbolic execution, and provides an approach for simplifying logical formulas with read and write operations. The described technique models memory with “logical arrays” like lists. However, the simplification rules are limited to simple forms of memory accesses and the method is operated on the final SR form of the program.

In the previously cited article of Cristian Cadar and Koushik Sen, the authors discuss the challenges of memory modeling.

There is then nowadays a field of research on how to reduce or optimized the number of these memory-access operations in programs analysis methods, while solving the drawbacks of the existing methods.

The present invention offers a solution to this need.

### SUMMARY OF THE INVENTION

The present invention allows deeply simplifying the created SR at translation time by operating on-the-fly, in an efficient manner.

Among others differences, the main differences with the known approaches are that the method does not abstract away the memory and simplifies memory operations both on-the-fly (in an efficient manner) and in a thorough manner, being able to handle complex forms of memory accesses (beyond the purely constant value case).

The invention will find advantageous applications such as:
activities: bug finding, automatic testing, program verification or validation or certification (safety and security), program repair, program optimization, reverse engineering, decompilation;
technical fields: software engineering, V & V, security or safety certification, quality assurance, compilation.

Still advantageously, the present invention is independent of the particular analysis to be later applied on the symbolic representation provided by the simplification process. Especially, it will benefit techniques such as symbolic execution, bounded model checking, interpolant-based model checking, abstract interpretation, flow-sensitive path-sensitive static analysis, and any of their variants (forward or backward or both, normal or relational, local or global, etc.).

To achieve the foregoing objects, a system, method and computer program product are provided in the appended claims.

Specifically, a computer implemented method is provided for performing symbolic execution on a symbolic representation of a computer program comprising a sequence of software instructions represented at least by variables, memories and expressions. The method is operated on-the-fly and comprises for each software instruction of the computer program:
analyzing an initial symbolic representation of a software instruction to determine if a simplification may be applied to any memory-access operation included in the initial symbolic representation of the software instruction;
in case of determining a simplification, generating a simplified symbolic representation of said software instruction to replace the initial symbolic representation; and
generating a new symbolic representation of the computer program with the simplified symbolic representation of said software instruction.

The invention further addresses a system comprising means adapted to carry out the steps of the method according to any one of method claims.

Another object is a computer program comprising instructions for carrying out the steps of the method according to any one of method claims when said computer program is executed on a suitable computer device.

Further aspects of the invention will now be described, by way of preferred implementation and examples, with reference to the accompanying figures.

### BRIEF DESCRIPTION OF THE DRAWINGS

The above and other items, features and advantages of the invention will be better understood by reading the following more particular description of the invention in conjunction with the figures wherein:

FIG. 1 is a block diagram of a standard architecture and a known process flow of a program analyzer using symbolic representation;

FIG. 2 is a block diagram of one architecture of the system of the present invention in an embodiment, and a process flow of a program analyzer using symbolic representation as per the present invention;

FIG. 3 is a block diagram to detail an embodiment of the simplification module of the present invention;

FIG. 4 details an embodiment of the base normalization module of the system of the present invention; and

FIG. 5 details an embodiment of the row access normalization module of the system of the present invention.

### DETAILED DESCRIPTION OF THE INVENTION

The terms and expressions listed below have the following meaning for the description of the present invention:
Syntax: represents the text of a program.
Semantic: represents the meaning of a program and its behavior as to the set of all possible executions, or the set of values that a variable can take at runtime.
Domain or Abstract Domain: represents an abstract value attached to a variable or to an expression of the program, and meaning something true on all the values taken by this variable or expression along all the executions of the program. For example, let's have a variable X. The expression ‘X \in 0 . . . 100’ is an abstract value of X meaning that the value of X is always between 0 and 100. There are many classes of domains in the literature (intervals, congruencies, polyhedral, equalities, etc.).
Propagation of abstract domain: also known as Value-Set Analysis or VSA, or Abstract Interpretation.
Symbolic expression: is a term, a syntactic expression associated to a variable, an expression of a program, allowing recalling how it has been computed during runtime.
Propagation of symbolic expressions: also known as Symbolic Execution.

For sake of clarity of the description, a software program to be analyzed by the process of the present invention is a sequence of instructions ‘instr’ that may be represented by a language with:
Variables: A, B, C, D, etc. . . . ; and
Memories: M_i

Furthermore, the main operations to be considered for the analysis are:
The variables assignments denoted as “variable:=expr”.

For example: “A:=X+Y−4” means the expression ‘X+Y−4’ is assigned to variable ‘A’;
The memory read operations denoted as “variable:=load(memoire, expr_addr)”.

For example: “A:=load(M, 5)” means reading into memory M at address ‘5’ and put the value into variable ‘A’, or

for example: “A:=load(M, X+10)” means reading into memory M the value at address ‘X+10′ and put it into variable ‘A’
The memory write operations denoted as “memoire:=store(memoire, expr_addr, expr_value)”.

For example: “M_1:=store(M_0, X, 100)” means that memory M_1 is obtained by writing into memory ‘M_0’ the value’100′ at addr ‘X’ of memory M_0.
The condition operations or the assumptions, typically denoted “assume(condition)”.

For example: “assume(X<=100)” means that in order to follow the execution path, the value of ‘X’ must be less than or equal to 100.

It is also to be noted that the expressions “expr, expr_addr, expr_value” are built from variables, from constants, from memories. The same is for the conditions or assumptions which are just a special case of expressions.

One skilled in the art knows that at the basis of the “Array Theory”, an array in a language machine is given explicitly, i.e. as a map ‘M’ with addresses for storing values as “address->value” (meaning the value is stored at the address).

Another point to consider is that at the assembly level, addresses and values are integers. For higher level languages, addresses are apart (e.g.: the “references” in Java), and the values are richer (e.g. integer, string, Boolean, float, struct, . . . ).

Reading memory M at address i is equivalent to looking at the value M [i].

Writing the value v in memory M at address i amounts to just modifying M [i], which is then denoted by: “M[i]: =v” or “M[i]<v”.

Now, one knows that when reasoning about programs handling a memory, it is common in Program Analysis to have an implicit representation of memory, wherein:
Writing “M[i]: =v” amounts to creating a new memory, noted M′ similar in every point to memory M except for the index i.
And as the two memories M and M′ are almost identical, it is more economical to represent them by their only difference, denotes as: M--(i,v)-->M′.
All the values of M′ may then easily retrieved just by “unfolding” the underlying writing string until going back to the very initial memory M_0 (at the start of the program). This unfolding may be denoted such as:

$$M\_ 0 -- ( i 1 , v 1 ) -- > M\_ 1 -- ( i 2 , v 2 ) -- > M\_ 2 -- ( i 3 , v 3 ) -- > … M -- ( i , v ) -- > {M}^{′} .$$

In the context of automatic reasoning, an essential point is the Read-Over-Write operation, denoted “RoW”. The RoW operation may be encountered with three cases, for an instruction of the type load(M′,addr) with M′ being if the form of store(M,i,v)
a first case, denoted RoW-1, when “i==addr”. As it is known that M′[i] is worth v (i.e. v being the last value written in M′), it is thus known that value “v” is read, so here the RoW-1 operation means load(M′, addr)==>v. Then in terms of simplification, the memory has been eliminated.
a second case, denoted RoW-2, when “i 0 addr”. As it is known that M and M′ differ only on the address addr, and that addr is not the address which is read, then the RoW-2 operation amounts to reading on M at address addr. So, a recursive reading is done on M: load (M′, addr)==>load (M, addr). Then, in terms of simplification, the automatic reasoning has “advanced” in the chain of writing.
a third case, denoted Split. One does not know if “i==addr” or “if i≠addr” (this case does not happen if i and addr are constant values, but as the reasoning is for a program these latters can be names of variables, and the equalities == or differences ≠ may vary depending on program inputs). This is a worst case for the automatic reasoning, and this implies either:
to lose precision: an assumption is then made that both (equality and difference) can be done and then the possible results are merged; or
to lose very strongly in efficiency: both cases are then separated into a case where “i==addr” is forced for the analysis, and another case where “i≠addr” is forced for the analysis.

So in the case of encountering a ‘Split’, a Read-over-Write operation on an array M′ obtained from N writes will therefore bring 2^{N} possibilities of a priori possible values for the load.

Therefore in this general context, the aim of the present invention, is to provide a low cost simplification process that minimizes the memory reading instructions, by intuiting as much as possible the cases of Read-over-Write operations of the type RoW-1 and RoW-2, in order to simplify the subsequent analyzes.

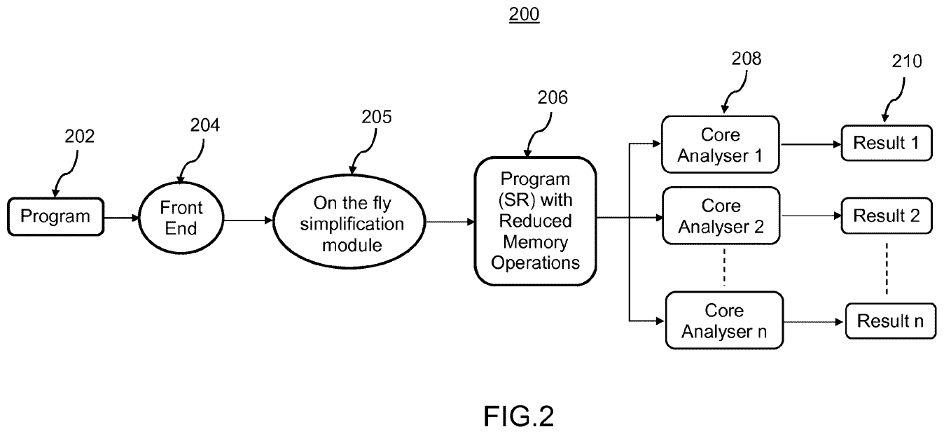

Referring now to FIG. 2, a block diagram of the architecture 200 of a program analyzer according to an embodiment of the present invention is described, along with the process flow among the different components.

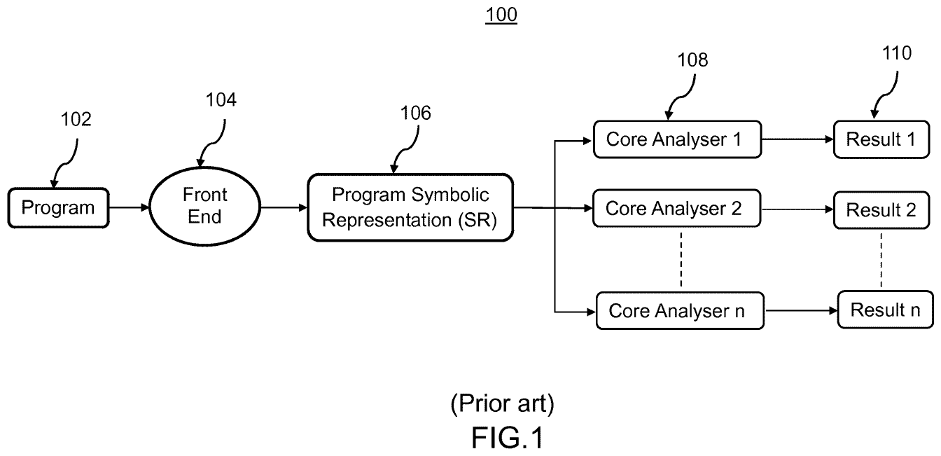

The general structure of the program analyzer using symbolic representation is almost similar to the architecture shown on FIG. 1, i.e. comprising an input program 202 to be analyzed, a front-end module 204, a program symbolic representation module 206, one or several core analyzer modules 208 and one or several output modules 210.

The program analyzer of the present invention, further comprises a symbolic representation (SR) simplification module 205 coupled between the front-end module 204 and the program symbolic representation module 206.

The SR simplification module 205 processes each SR instruction of the program to generate when appropriate simplified SR instructions and at the end to output 206 a simplified SR of the whole program.

Advantageously, the SR simplification module 205 operates “on-the-fly” simplification of one instruction at a time, which result at the end in a simplified complete SR (compared to prior art) where many memory-access operations have been simplified or removed from the original sequence of instructions of the program under analysis.

The process flow of the program analyzer is then a computer implemented method for performing symbolic execution on a symbolic representation of a computer program comprising a sequence of software instructions, the method being operated on-the-fly and comprising for each software instruction of the computer program:
analyzing an initial symbolic representation of the software instruction to determine if a simplification may be applied to memory-access operations included in the initial symbolic representation of said software instruction;
in case of simplification, generating a simplified symbolic representation of said software instruction to replace the initial symbolic representation; and
generating a new symbolic representation of the computer program with the simplified symbolic representation of said software instruction.

Having an “on-the-fly” simplification, allows a simplification operation to be performed on the SR of each instruction during the translation of the program under analysis. This offers the efficient advantage of not having to wait for a first complete translation of the program before performing a simplification of the SR, as it is the case in the prior art techniques.

The process of simplification of the present invention allows performing deep simplifications on memory-access operations, both read-over-write operation and write-over-write operations.

In a context of a program having only constant memory accesses, the iterative simplification process of the invention allows to get rid of all memory operations, thereby providing a drastically simplifies SR, and thus a less costly analyzing process.

Advantageously, the simplification process of the invention is independent of the specific target language of the program to be analyzed, the only requirement being that the program allows explicit memory operations. Therefore, programming languages such as C, C++, Ilvm bitcode, Java bytecode, assembly languages, machine code, EVM, etc. are all acceptable software language for applying the simplification process.

Another advantage of the simplification process of the invention is that it is independent of any specific target SR to be used, which can be indifferently a representation in a logical language, a term language or an intermediate representation (IR).

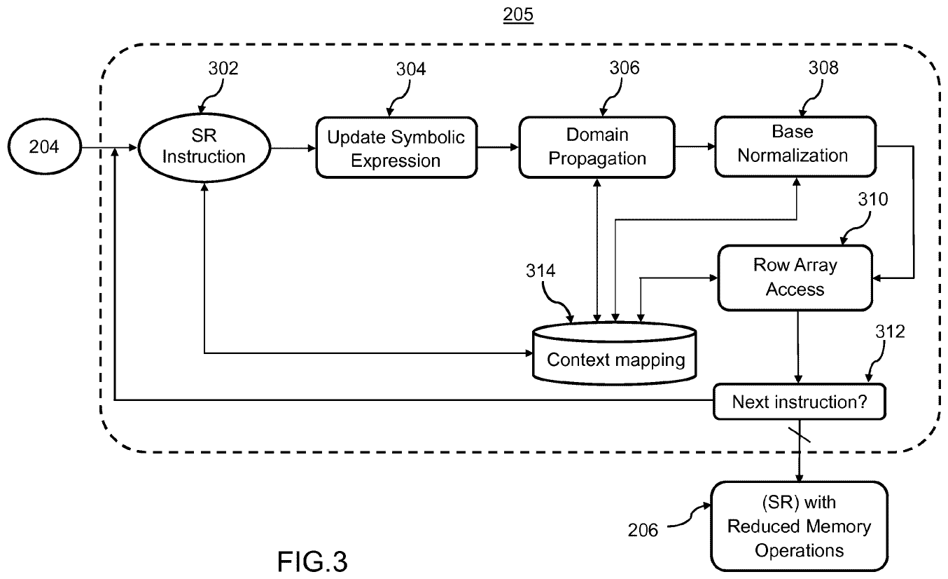

Moreover, the present invention offers a simplification process which is independent of the particular analysis to be applied on the resulting simplified SR. Referring now to FIG. 3, a functional embodiment of the SR simplification module 205 is described.

The SR simplification module 205 receives, in a SR receiving module 302, a SR of one instruction as input, provided by the front-end module 204 which treats the program under analysis sequentially to send one SR instruction at a time to the SR instruction receiving module 302.

The benefit of operating on one instruction at a time (i.e. “on-the-fly”), is to allow later on-the-fly analysis, but also to allow to directly build a simplified code as a whole, instead of, as in prior art, building first a long non-simplified code and then simplifying it, which can be costly.

The further benefit of operating on one instruction at a time, is that it allows to directly update internal structures necessary to the latter SR instruction treatments, instead of, as in prior art, building a simplified SR with a fixed structure.

The SR instruction receiving module 302 is coupled to an Update Symbolic Expression module 304 which is coupled to a Context Mapping module 314.

The Context Mapping module 314 allows storing information on computation history. Particularly, context mapping information is information on all previous computation made with variables and memories included in the sequence of software instructions of a program under analysis.

For each variable of the program, the Context Mapping module allows storing the symbolic value of the variable (i.e. how the value is computed). For example:

for an instruction with variable such as “A:=X+15”, the context mapping module stores “A-->X+15”; and for an instruction with memories such as “M2:=store(M1,A,V)”, the context mapping module stores “M2-->store(M1, A, V)”. The context mapping module 314 may also store the previously computed domains for each variable. For example, if the context mapping module stores “A-->100 . . . 1000”, then the simplification program when processing an instruction, knows that variable A contains a value between 100 and 1000.

Back to FIG. 3, the update symbolic expression module 304 allows updating the computations for the corresponding variables in the current context mapping according to the expression of the current SR instruction received.

For example, on receiving an instruction denoted “Y:=A+10” and having the previous context mapping, the update symbolic expression module allows updating the context mapping as follow:

$$A -- > X + 15 \\ M 2 -- > store ( M 1 , A , V ) \\ Y -- > A + 10.$$

Next on FIG. 3, the output of the update symbolic expression module 304 is coupled to a Domain Propagation module 306 which is also coupled to the Context Mapping module 314.

The Domain propagation module 306 allows updating the corresponding domains of the current context mapping according to the domains of the current SR instruction under analysis. For example, still for the same above example of an instruction denoted “Y:=A+10”, the information on the domains in the context mapping is updated by the following new domains:

$$A -- > 100 … 1000 \\ Y -- > 110 … 1010.$$

Next on FIG. 3, the output of the Domain propagation module 306 is coupled to a Base Normalization module 308 which is also coupled to the Context Mapping module 314.

The Base Normalization module 308 allows processing each current SR instruction according to the current context mapping in order to reduce the number of memory access.

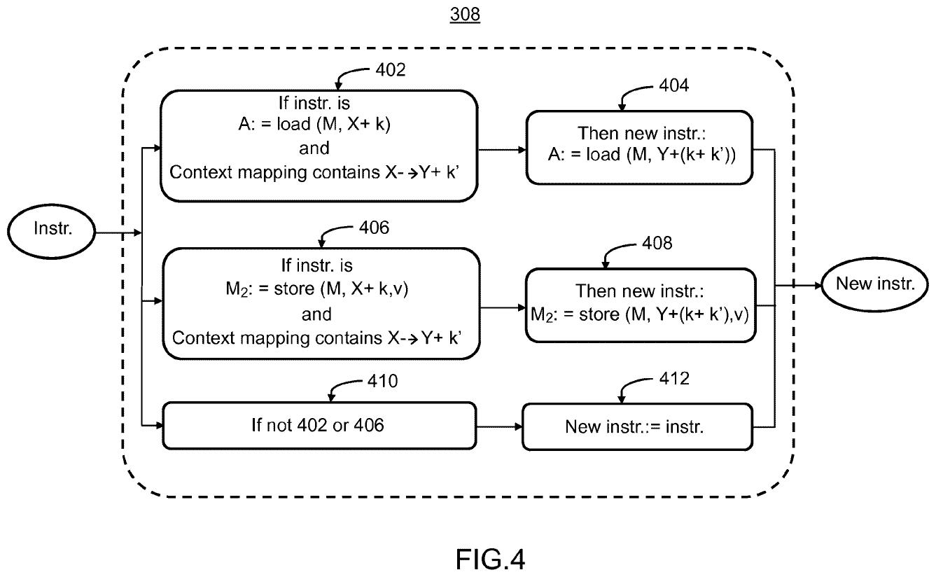

FIG. 4 details an embodiment of the base normalization module 308 of the system of the present invention.

The base normalization module receives the SR of the instruction under analysis (Instr.), and determines if a simplification may be applied depending on several conditions.

It is to be appreciated that the current SR instruction may already have been simplified or not previously during the symbolic expression analysis 304 and/or the domain analysis 306.

If none of these conditions is met (410), the current SR instruction is not modified (412), and the output of the base normalization module is the current SR instruction as received by the base normalization module. In an embodiment, if the instruction is not a Store one nor a Load one, no modification is applied and the SR instruction is output from the Base normalization module as received.

In an embodiment, the base normalization analysis allows modifying, i.e. simplifying, the form of the read and write address in the received SR instruction depending on at least one of two conditions.

The two conditions for reducing the number of memory access may be to determine:
(402) if the symbolic representation of the software instruction is a read operation (load(M, Addr)) with the address of the software instruction being an expression in the form “X+k” of a variable X and a constant k; and if the context mapping contains an expression in the form “X-->Y+k′” of a variable Y and a constant k′ for the address X;
   or
(406) if the symbolic representation of the software instruction is a write operation (store(M,Addr,Val)) with the address of the software instruction being an expression in the form “X+k” of a variable X and a constant k.

If one of these two conditions is fulfilled, the expression of the address in the current symbolic representation of the software instruction is replaced by a new expression in the form “Y+(k+k′)”, respectively (404) in the form of “load(M, Y+(k+k′))” for the read operation, or (408) in the form of “store(M,Y+(k+k′),Val)” for the write operation.

The base normalization module allows then generating a new symbolic representation of the software instruction (NewInstr).

In a further embodiment, the process comprises a step of updating the context mapping with the new expression.

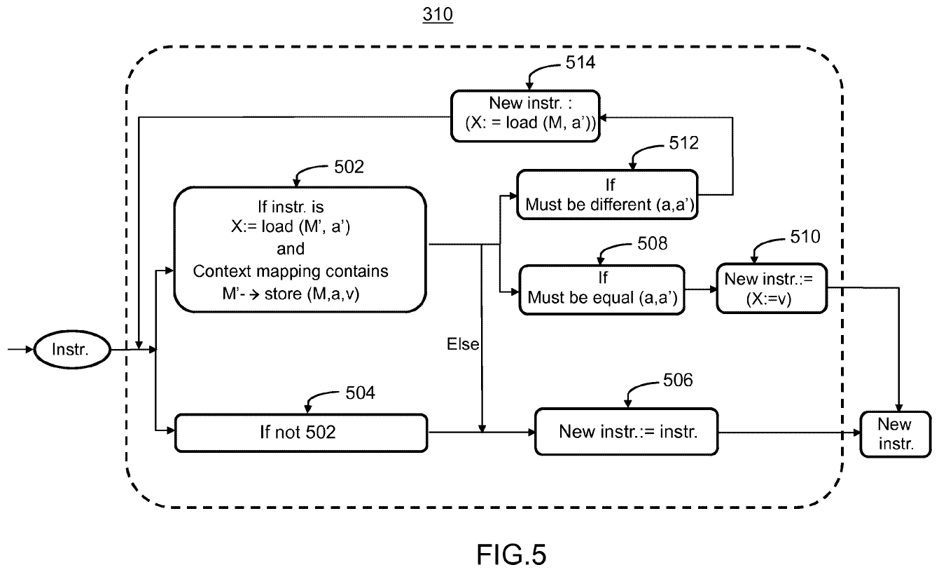

FIG. 5 details an embodiment of the row access normalization module 310 of the system of the present invention. Generally speaking, the row array access normalization module allows updating the array representation in the context mapping and providing new simplified instructions (NewInstr).

On receiving an instruction, the Row Array Access Normalization module analyses the form of the instruction with the content of the current mapping context, to determine if a modified instruction (NewInstr) may be generated while simplifying the memory accesses (row access) as much as possible.

The process of row access normalization operates as follow:

It first determines (502) if the received instruction (either the same as the initial SR instruction or already simplified through the previous modules) is in the form of a load of a value a′ to a memory M′, such as for example “X: =load (M′, a′)”, and if the current Context Mapping contains an expression for the memory M′ defined in the received instruction, such as for example “M′->store (M, a, V)”.

Else (504), if the received instruction is not a load, or if the received instruction is a load to a memory M′ but there is not an existing expression for the considered memory M′ in the current context mapping, then this means the load instruction may not be simplified (506), and the process allows providing a SR of the program (206) with the initial SR load instruction.

Referring back to the determination (502) that a simplification may be applied on the received instruction, the process continues with a comparison between the value a in the received load instruction and the value a′ in the existing expression in the current context mapping.

If the values a and a′ are equal (508), i.e. a condition “must_be_equal (a, a′)” is fulfilled, then the process allows (510) returning a new instruction (NewInstr:=“X:=V”).

A definition of the condition “must_be_equal (a, a′)” may be to check that the expressions a and a′ are syntactically equal to valid the condition.

If the values a and a′ are different (512), i.e. a condition “must_be_different (a, a′)” is fulfilled, then the process allows (514) returning a new instruction (NewInstr:=“X:=load(M, a′)”) including the previously accessed memory M and the new value a′, and the process loops back to the row array access normalization entry (502) to operate on this new instruction. A definition of the condition “must_be_different (a, a′)” may be to check:
if the value a is in a form “X+k” and the value a′ is in a form “X+k′”, with k and k′ being two different constants, then the condition is fulfilled; or
if the current Context Mapping contains domain information D(a) and D(a′) respectively for the values a and a′ such that there is no intersection between the domains, then the condition is fulfilled;
otherwise the condition is wrong.

Finally, it is appreciated that the aim of the row access normalization module is to reduce as much as possible the presence of “RoW” type term, i.e. the presence of readings on memories obtained from writes.

To summarize, the essential points of the proposed technique are: A new symbolic representation for memory, integrated during the code-to-SR translation process and allowing efficient on-the-fly simplifications of read and write operations.

The “on the fly” characteristic allows to process the instructions of the program one by one without ever going back, and without waiting until the whole program is available in memory.

This further provides the ability to simplify memory accesses even in the event of symbolic accesses (i.e. of the “variable+constant” form), whereas the state of the art was at best limited to the case of constant accesses.

The differences and resulting improvements over existing techniques are significant: while accesses with symbolism of a form considered are very common, accesses with constant addresses are not very common, hence benefiting a significant improvement in simplification.

From a technical point of view, major differences stand on the processing of the “must_be_different” case of RoW access normalization, on the base normalization process which is a new essential module allowing to decrease the number of possible address bases.

The present approach is generic regarding a core analyzer. Hence, the results can be of very different natures. This include for example:
a certificate that the PUA behaves as expected (ex: no bufferoverflow) for all input [formal verification];
a test input demonstrating the presence of a certain bug (ex: an input triggering a buffer overflow) [formal bug hunting];
a test suite achieving a high-level of coverage (ex: MCDC coverage, required in aeronautics) [formal testing];
a bound of the worst-case execution time of the program [performance evaluation];
providing dependences between program parts [program optimization].

1. A computer implemented method for performing symbolic execution on a symbolic representation of a computer program comprising a sequence of software instructions represented at least by variables, memories and expressions, the method being operated on-the-fly and comprising for each software instruction of the computer program:
analyzing an initial symbolic representation of a software instruction to determine if a simplification may be applied to any memory-access operation included in the initial symbolic representation of the software instruction;
in case of determining a simplification, generating a simplified symbolic representation of said software instruction to replace the initial symbolic representation; and
generating a new symbolic representation of the computer program with the simplified symbolic representation of said software instruction.

2. The computer implemented method of claim 1, wherein the step of analyzing an initial symbolic representation of a software instruction comprises:
determining if the initial symbolic representation of the software instruction comprises a symbolic expression of a read or a write operation;
if not, generating a new symbolic representation of the computer program with the initial symbolic representation of said software instruction; and
else, processing the symbolic expression of the read operation or of the write operation.

3. The computer implemented method of claim 1, wherein the analyzing step comprises using context mapping information to determine if a simplification may be applied to the initial symbolic representation of the software instruction, wherein context mapping information is information on previous computations made with variables and memories included in the sequence of software instructions, and information on previous computed abstract domains wherein an abstract domain representing an abstract value attached to a variable or to an expression of the computer program.

4. The computer implemented method of claim 3, further comprising a step of updating abstract domains of the context mapping according to abstract domains of the initial symbolic representation of the software instruction.

5. The computer implemented method of claim 1, wherein the step of analyzing the initial symbolic representation of a software instruction further comprises a step of reducing the number of memory access.

6. The computer implemented method of claim 3, wherein the step of reducing the number of memory access comprises the steps of determining:
that the symbolic representation of the software instruction is either a write operation (store(M,Addr,Val)) or a read operation (load(M, Addr)), with the address of the software instruction being an expression in the form “X+k” of a variable X and a constant k; and
that the context mapping contains an expression in the form “X-->Y+k′” of a variable Y and a constant k′ for the address X;
to replace the expression of the address in the current symbolic representation of the software instruction by a new expression in the form “Y+(k+k′)”, thereby generating a new symbolic representation of the software instruction, in the form of “store(M,Y+(k+k′),Val)” for the write operation or in the form of “load(M, Y+(k+k′))” for the read operation.

7. The computer implemented method of claim 6, further comprising a step of updating the context mapping with the new expression.

8. The computer implemented method of claim 1, wherein the step of reducing the number of memory access comprises the steps of determining that the received instruction is in the form “X: =load (M′, a′)” of a load of a value a′ to a memory M′, and that the current context mapping contains an expression for the memory M′ defined in the received instruction, to generate a simplified symbolic representation of said software instruction to replace the initial symbolic representation.

9. The computer implemented method of claim 8, further comprising before generating a simplified symbolic representation of said software instruction, a step of determining if the value a′ in the load instruction is equal to a value a defined in the expression of the current context mapping.

10. A system comprising means adapted to carry out the steps of the method according to claim 1.

11. A computer program comprising instructions for carrying out the steps of the method according to claim 1 when said computer program is executed on a suitable computer device.
